(19) United States
(12) Patent Application Publication
(10) Pub. No.: US 2025/0137232 A1
(43) Pub. Date: May 1, 2025

(54) Hydraulic Circuit for Construction Machine

(71) Applicant: Caterpillar SARL, Geneva (CH)

(72) Inventors: Hideki NAKAJIMA, Akashi-shi (JP); Toshikazu KOGA, Akashi-shi (JP); Ryota MINAGI, Akashi-shi (JP); Koichi KIYASU, Akashi-shi (JP)

(73) Assignee: Caterpillar SARL, Geneva (CH)

(21) Appl. No.: 18/865,975

(22) PCT Filed: May 15, 2023
(86) PCT No.: PCT/EP2023/025228

§ 371 Date: Nov. 14, 2024

(30) Foreign Application Priority Data
May 16, 2022 (JP) 2022-080131

(51) Int. Cl. E02F 9/22; E02F 9/20; E02F 9/26; F15B 15/18

(52) U.S. Cl. CPC E02F 9/2203; E02F 9/2004; E02F 9/2267; E02F 9/2271; E02F 9/2275; E02F 9/2296; E02F 9/26; F15B 15/18

(57) ABSTRACT

Task: A hydraulic circuit for a construction machine having good energy efficiency is provided. Means for Resolution: A hydraulic circuit includes a motor generator, a pump motor connected to the motor generator, a boom cylinder, a rod-side pipeline that connects the pump motor and a rod-side port of the boom cylinder, a cap-side pipeline that connects the pump motor and a cap-side port of the boom cylinder, an operating device that outputs a signal for operating the boom cylinder, and a controller that performs circuit control based on a signal output from the operating device. In a case where a rod push-out signal for the boom cylinder is output from the operating device, hydraulic oil flows from the rod-side pipeline to the cap-side pipeline via the pump motor. In a case where a rod retraction signal for the boom cylinder is output from the operating device, hydraulic oil flows from the cap-side pipeline to the rod-side pipeline via the pump motor.

### TECHNICAL FIELD

The present invention relates to a hydraulic circuit for a construction machine with a boom.

### BACKGROUND ART

A hydraulic excavator as a typical example of construction machines with a boom includes a lower traveling body, an upper swiveling body supported by the lower traveling body, and a front attachment attached to the upper swiveling body. The front attachment includes a boom swingably supported by the upper swiveling body, an arm swingably supported at the tip end of the boom, and a bucket swingably supported at the tip end of the arm.

A hydraulic circuit for a hydraulic excavator includes a hydraulic pump, a hydraulic actuator (such as a boom cylinder, an arm cylinder, and a bucket cylinder) that is operated by oil discharged from the hydraulic pump, an operating device that outputs a signal for operating the hydraulic actuator, and a directional switching valve for switching the supply direction of hydraulic oil from the hydraulic pump to the hydraulic actuator based on a signal output from the operating device.

In the hydraulic excavator, the oil discharged from the hydraulic pump is supplied to the hydraulic actuator via the directional switching valve based on the signal output from the operating device, and the hydraulic actuator is operated to swing the front attachment (see Patent Document 1, for example).

### RELATED ART DOCUMENT

### Patent Document

Patent Document 1: JP-A-2013-23821

### SUMMARY OF THE INVENTION

### Problem that the Invention is to Solve

However, in hydraulic excavators of the related art, the pressure loss in the directional switching valve is large, and there is room for improvement in terms of energy efficiency.

When the bucket is off the ground, the weight of the boom, arm, and bucket acts on the boom cylinder. Thus, in the case of lowering the boom, the pressure for operating the boom cylinder (retracting a piston rod of the boom cylinder into a cylinder tube) is lower than the pressure for operating the arm cylinder and the bucket cylinder.

Therefore, in the case of operating other hydraulic actuators such as an arm cylinder together with the boom cylinder, although it is necessary to increase the discharge pressure of the hydraulic pump to the extent that other hydraulic actuators can be operated, the pressure of the hydraulic oil supplied to the boom cylinder is decreased by the directional switching valve for the boom. Accordingly, there is a problem that a large pressure loss occurs in the directional switching valve, and an improvement in energy efficiency is desired.

An object of the present invention is to provide a hydraulic circuit for a construction machine with good energy efficiency.

### Means for Solving the Problem

According to the present invention, a hydraulic circuit for a construction machine is provided which solves the problems mentioned above, as follows. That is, there is provided:
“a hydraulic circuit for a construction machine with a boom, the hydraulic circuit including
a motor generator,
a variable displacement bidirectional pump motor connected to the motor generator,
a boom cylinder for operating the boom,
a rod-side pipeline that connects the pump motor and a rod-side port of the boom cylinder,
a cap-side pipeline that connects the pump motor and a cap-side port of the boom cylinder,
an operating device that outputs a signal for operating the boom cylinder, and
a controller that performs circuit control based on a signal output from the operating device, in which
in a case where a rod push-out signal for the boom cylinder is output from the operating device, hydraulic oil flows from the rod-side pipeline to the cap-side pipeline via the pump motor, and
in a case where a rod retraction signal for the boom cylinder is output from the operating device, hydraulic oil flows from the cap-side pipeline to the rod-side pipeline via the pump motor.

Preferably, the hydraulic circuit further includes a cap-side pressure sensor that detects pressure in the cap-side pipeline, and in a case where the rod retraction signal for the boom cylinder is output from the operating device, the controller causes the motor generator to drive the pump motor when the pressure detected by the cap-side pressure sensor is less than a predetermined value, and allows the motor generator to be driven by the pump motor when the pressure detected by the cap-side pressure sensor is equal to or higher than the predetermined value.

The hydraulic circuit may further include a rod-side return pipeline that connects the rod-side pipeline and a hydraulic oil tank, and an electromagnetic proportional on-off valve disposed in the rod-side return pipeline, and when the rod retraction signal for the boom cylinder is output from the operating device, the controller may open the electromagnetic proportional on-off valve to discharge surplus hydraulic oil from the rod-side return pipeline.

It is preferable that the controller adjusts an opening degree of the electromagnetic proportional on-off valve according to the signal output from the operating device, and controls an amount of surplus hydraulic oil discharged from the rod-side return pipeline.

The hydraulic circuit may further include a cap-side return pipeline that connects the cap-side pipeline and a hydraulic oil tank, and an electromagnetic proportional relief valve disposed in the cap-side return pipeline, and when the rod retraction signal for the boom cylinder is output from the operating device, the controller may reduce relief pressure of the electromagnetic proportional relief valve to discharge surplus hydraulic oil from the cap-side return pipeline.

It is desirable that the hydraulic circuit further includes a rod-side replenishment pipeline connected to the rod-side pipeline, a rod-side check valve disposed in the rod-side replenishment pipeline, a cap-side replenishment pipeline connected to the cap-side pipeline, and a cap-side check valve disposed in the cap-side replenishment pipeline, and in a case where the rod push-out signal for the boom cylinder is output from the operating device, the rod-side check valve opens to replenish the rod-side pipeline with hydraulic oil, or the cap-side check valve opens to replenish the cap-side pipeline with hydraulic oil.

The cap-side pipeline is provided with a drift reduction valve that allows flow from the pump motor to the cap-side port and blocks flow from the cap-side port to the pump motor, and in a case where the rod retraction signal for the boom cylinder is output from the operating device, the controller can open the drift reduction valve to allow flow from the cap-side port to the pump motor.

It is preferable that the controller adjusts a rotation speed of the motor generator and a displacement of the pump motor according to the signal output from the operating device.

### Advantage of the Invention

In the hydraulic circuit for a construction machine according to the present invention, in a case where a rod push-out signal for the boom cylinder is output from the operating device, hydraulic oil flows from the rod-side pipeline to the cap-side pipeline via the pump motor, and in a case where a rod retraction signal for the boom cylinder is output from the operating device, hydraulic oil flows from the cap-side pipeline to the rod-side pipeline via the pump motor. Therefore, a directional switching valve for switching the operating direction of the boom cylinder is not required. Accordingly, no pressure loss occurs in the directional switching valve, and good energy efficiency is achieved.

### BRIEF DESCRIPTION OF THE DRAWINGS

FIG. 1 is a circuit diagram illustrating a hydraulic circuit of the present invention.

FIG. 2 is a schematic diagram of a hydraulic excavator equipped with the hydraulic circuit illustrated in FIG. 1 (state in which an external force acts on a boom cylinder in a rod retracting direction).

FIG. 3 is a circuit diagram illustrating the flow of hydraulic oil in a case where a rod push-out signal is output in the state illustrated in FIG. 2.

FIG. 4 is a circuit diagram illustrating the flow of hydraulic oil in a case where a rod retraction signal is output in the state illustrated in FIG. 2.

FIG. 5 is a schematic diagram illustrating a state in which the hydraulic excavator illustrated in FIG. 2 tilts a machine body using a front attachment (state in which an external force acts on the boom cylinder in a rod push-out direction).

FIG. 6 is a circuit diagram illustrating the flow of hydraulic oil in a case where a rod push-out signal is output in the state illustrated in FIG. 5.

FIG. 7 is a circuit diagram illustrating the flow of hydraulic oil in a case where a rod retraction signal is output in the state illustrated in FIG. 5 (when an electromagnetic proportional on-off valve is opened).

FIG. 8 is a circuit diagram illustrating the flow of hydraulic oil in a case where a rod retraction signal is output in the state illustrated in FIG. 5 (when an electromagnetic proportional relief valve is opened).

### BEST MODE FOR CARRYING OUT THE INVENTION

An embodiment of a hydraulic circuit for a construction machine according to the present invention will be described below with reference to the accompanying drawings.

### Hydraulic Circuit 2

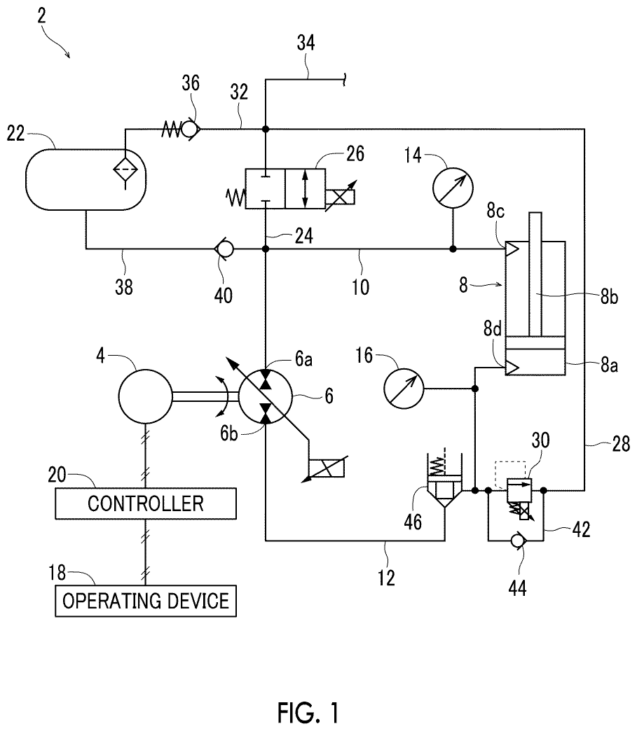

A hydraulic circuit 2 illustrated in FIG. 1 can be mounted on a construction machine with a boom (for example, a hydraulic excavator). The hydraulic circuit 2 includes a motor generator 4, a variable displacement bidirectional pump motor 6 connected to the motor generator 4, and a boom cylinder 8 for operating the boom.

### Motor Generator 4, Pump Motor 6

A battery (not illustrated) is connected to the motor generator 4. In a case where electric power is supplied to the motor generator 4 from the battery, the motor generator 4 functions as an electric motor, and the pump motor 6 driven by the motor generator 4 acts as a hydraulic pump.

When the motor generator 4 rotates forward to cause the pump motor 6 to rotate forward, low-pressure hydraulic oil is sucked from a first port 6a of the pump motor 6, and high-pressure hydraulic oil is discharged from a second port 6b of the pump motor 6. On the other hand, when the motor generator 4 rotates in reverse to cause the pump motor 6 to rotate in reverse, low-pressure oil is sucked from the second port 6b, and high-pressure oil is discharged from the first port 6a.

Further, in a case where the motor generator 4 functions as a generator, the pump motor 6 acts as a hydraulic motor to drive the motor generator 4.

When high-pressure oil flows into the first port 6a of the pump motor 6 and low-pressure oil flows out from the second port 6b, the pump motor 6 rotates forward to cause the motor generator 4 to rotate forward. On the other hand, when high-pressure oil flows into the second port 6b of the pump motor 6 and low-pressure oil flows out from the first port 6a, the pump motor 6 rotates in reverse to cause the motor generator 4 to rotate in reverse. Electric power generated by forward or reverse rotation of the motor generator 4 is accumulated in the battery.

Note that oil discharged from the pump motor 6 is supplied only to the boom cylinder 8, and the hydraulic actuators (arm cylinder, bucket cylinder, and the like) other than the boom cylinder 8 are supplied with hydraulic oil from other hydraulic pumps other than the pump motor 6. Other hydraulic pumps are driven by drive sources other than the motor generator 4 (electric motor, engine, and the like). Therefore, in the hydraulic circuit 2, there is no interference between the circuit of the boom cylinder 8 and the circuit of other hydraulic actuators, and the operability is excellent.

### Boom Cylinder 8, Rod-Side Pipeline 10, Cap-Side Pipeline 12

The boom cylinder 8 includes a cylinder tube 8a and a piston rod 8b. A rod-side port 8c of the boom cylinder 8 is connected to the first port 6a of the pump motor 6 via a rod-side pipeline 10. A cap-side port 8d of the boom cylinder 8 is connected to the second port 6b of the pump motor 6 via a cap-side pipeline 12.

A rod-side pressure sensor 14 that detects the pressure in the rod-side pipeline 10 is provided in the rod-side pipeline 10. A cap-side pressure sensor 16 that detects the pressure in the cap-side pipeline 12 is provided in the cap-side pipeline 12.

As illustrated in FIG. 1, the hydraulic circuit 2 includes an operating device 18 that outputs a signal for operating the boom cylinder 8, and a controller 20 that performs circuit control based on the signal output from the operating device 18.

### Operating Device 18

The operating device 18 may have an input device (for example, a joystick or a slide switch) that increases an output intensity of an electrical signal as the amount of operation increases. The operating device 18 may output a signal for operating the boom cylinder 8 as well as a signal for operating a hydraulic actuator other than the boom cylinder 8.

### Controller 20

The controller 20 includes a computer having a processing device and a storage device. As illustrated in FIG. 1, the operating device 18 and the motor generator 4 are electrically connected to the controller 20. Although not illustrated, the pump motor 6, the rod-side pressure sensor 14, and the cap-side pressure sensor 16 are also electrically connected to the controller 20.

The hydraulic circuit 2 of the illustrated embodiment includes a rod-side return pipeline 24 that connects the rod-side pipeline 10 and a hydraulic oil tank 22, an electromagnetic proportional on-off valve 26 disposed in the rod-side return pipeline 24, a cap-side return pipeline 28 that connects the cap-side pipeline 12 and the hydraulic oil tank 22, and an electromagnetic proportional relief valve 30 disposed in the cap-side return pipeline 28.

The rod-side return pipeline 24 and the cap-side return pipeline 28 merge before the hydraulic oil tank 22 and are connected to the hydraulic oil tank 22 via a confluence return pipeline 32. Another return pipeline 34 for returning hydraulic oil discharged from hydraulic actuators other than the boom cylinder 8 to the hydraulic oil tank 22 is connected to the confluence return pipeline 32. Furthermore, the confluence return pipeline 32 is provided with a back pressure check valve 36 for make-up.

Although not illustrated, the electromagnetic proportional on-off valve 26 and the electromagnetic proportional relief valve 30 are electrically connected to the controller 20. The electromagnetic proportional on-off valve 26 closes the oil passage in a case where no signal is output from the controller 20 and opens the oil passage when the signal is sent from the controller 20. The opening degree of the electromagnetic proportional on-off valve 26 is adjusted according to a signal from the controller 20. Further, the relief pressure of the electromagnetic proportional relief valve 30 is maintained at the initial value in a case where no signal is output from the controller 20, and is changed from the initial value according to the signal from the controller 20.

As illustrated in FIG. 1, the hydraulic circuit 2 further includes a rod-side replenishment pipeline 38 connected to the rod-side pipeline 10, a rod-side check valve 40 disposed in the rod-side replenishment pipeline 38, a cap-side replenishment pipeline 42 connected to the cap-side pipeline 12, and a cap-side check valve 44 disposed in the cap-side replenishment pipeline 42.

The rod-side replenishment pipeline 38 connects the rod-side pipeline 10 and the hydraulic oil tank 22. The rod-side check valve 40 allows flow from the hydraulic oil tank 22 to the rod-side pipeline 10 and blocks flow from the rod-side pipeline 10 to the hydraulic oil tank 22.

The cap-side replenishment pipeline 42 in the illustrated embodiment is connected to the cap-side return pipeline 28 in a manner that bypasses the electromagnetic proportional relief valve 30, and the cap-side check valve 44 and the electromagnetic proportional relief valve 30 are disposed in parallel. The cap-side check valve 44 allows flow from the cap-side replenishment pipeline 42 to the cap-side pipeline 12 and blocks flow from the cap-side pipeline 12 to the cap-side replenishment pipeline 42.

In the illustrated embodiment, the cap-side pipeline 12 is provided with a drift reduction valve 46. The drift reduction valve 46 allows flow from the second port 6b of the pump motor 6 to the cap-side port 8d of the boom cylinder 8 and, in principle, blocks flow from the cap-side port 8d to the second port 6b.

Although not illustrated, the drift reduction valve 46 is electrically connected to the controller 20. The controller 20 opens the drift reduction valve 46 in a case where a rod retraction signal for the boom cylinder 8 is output from the operating device 18 to allow flow from the cap-side port 8d to the second port 6b.

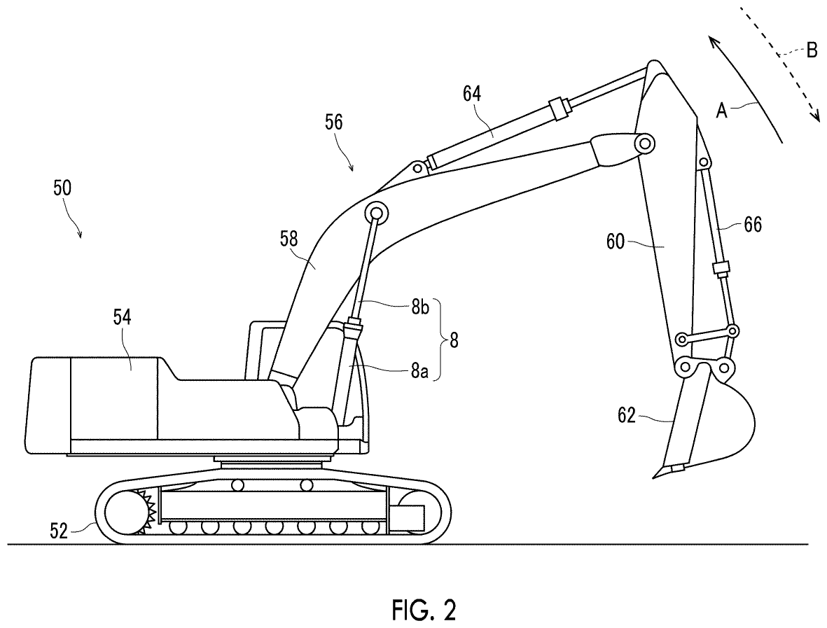

FIG. 2 illustrates a hydraulic excavator 50 as an example of a construction machine on which the hydraulic circuit 2 described above can be mounted. The hydraulic excavator 50 includes a lower traveling body 52, an upper swiveling body 54 rotatably supported by the lower traveling body 52, and a front attachment 56 attached to the upper swiveling body 54.

The front attachment 56 includes a boom 58 swingably supported by the upper swiveling body 54, an arm 60 swingably supported at the tip end of the boom 58, and a bucket 62 swingably supported at the tip end of the arm 60. In addition, the front attachment 56 is provided with the boom cylinder 8 for swinging the boom 58, an arm cylinder 64 for swinging the arm 60, and a bucket cylinder 66 for swinging the bucket 62.

The base end of the cylinder tube 8a of the boom cylinder 8 is connected to the upper swiveling body 54, and the tip end of the piston rod 8b is connected to the boom 58. Then, when the piston rod 8b is pushed out from the cylinder tube 8a, the boom 58 swings in the direction indicated by a solid arrow A in FIG. 2. Further, when the piston rod 8b is retracted into the cylinder tube 8a, the boom 58 swings in the direction indicated by a dotted arrow B in FIG. 2.

Next, the operation of the hydraulic circuit 2 for a construction machine as described above will be described.

In a case where the operating device 18 is not operated, no signal is output from the operating device 18 to the controller 20. In this case, the motor generator 4 and the pump motor 6 do not operate, and the hydraulic oil in the rod-side pipeline 10 and the cap-side pipeline 12 does not flow. Therefore, the boom cylinder 8 does not operate.

When the boom cylinder 8 is stopped and the bucket 62 is off the ground as illustrated in FIG. 2, the weight of the front attachment 56 acts on the boom cylinder 8, that is, the external force acts on the boom cylinder 8 in the rod retracting direction. Therefore, the pressure in the cap-side pipeline 12 increases.

However, in the illustrated embodiment, the drift reduction valve 46 blocks the flow from the cap-side port 8d to the second port 6b of the pump motor 6 unless the operating device 18 outputs a rod retraction signal. Therefore, the position of the piston rod 8b of the boom cylinder 8 is held, and the natural lowering of the boom 58 is prevented. In the above state, no pressure builds up inside the rod-side pipeline 10.

### 1. Rod Push-Out When External Force Acts in Rod Retracting Direction

In the state illustrated in FIG. 2, there is no pressure in the rod-side pipeline 10, and the pressure detected by the rod-side pressure sensor 14 becomes less than a predetermined value. Then, when a rod push-out signal for the boom cylinder 8 is output from the operating device 18, the controller 20 supplies electric power from the battery to the motor generator 4 to rotate the motor generator 4 forward. This causes the pump motor 6 to rotate forward. In other words, the motor generator 4 functions as an electric motor and the pump motor 6 acts as a hydraulic pump.

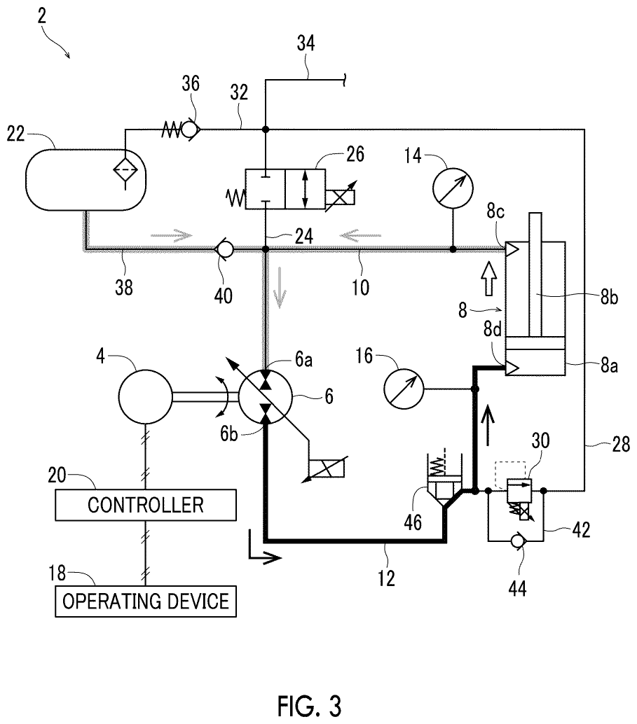

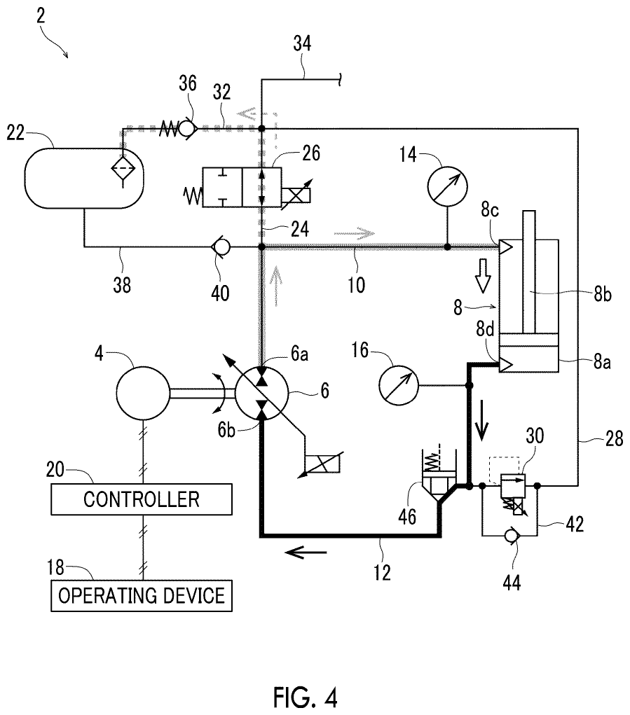

Then, as illustrated in FIG. 3, low-pressure hydraulic oil in the rod-side pipeline 10 is sucked into the first port 6a of the pump motor 6, and high-pressure hydraulic oil is discharged from the second port 6b to the cap-side pipeline 12. That is, hydraulic oil flows from the rod-side pipeline 10 to the cap-side pipeline 12 via the pump motor 6. In FIG. 3, the flow of high-pressure hydraulic oil is indicated by a thick black line, and the flow of low-pressure hydraulic oil is indicated by a thick gray line. Further, the same applies to FIGS. 4 and 6 to 8 as well.

Further, since hydraulic oil flows out from the rod-side port 8c of the boom cylinder 8 into the rod-side pipeline 10 and hydraulic oil flows into the cap-side port 8d from the cap-side pipeline 12, the piston rod 8b is pushed out from the cylinder tube 8a. Accordingly, the boom 58 swings (rises) in the direction indicated by the solid arrow A in FIG. 2.

As described above, since the drift reduction valve 46 allows the flow from the second port 6b of the pump motor 6 to the cap-side port 8d, when the discharge pressure of the pump motor 6 exceeds the pressure of the cap-side port 8d, the drift reduction valve 46 opens.

In a case where the piston rod 8b is pushed out from the cylinder tube 8a, the amount of hydraulic oil flowing out from the rod-side port 8c is smaller than the amount of hydraulic oil flowing into the cap-side port 8d by the volume of the piston rod 8b. Therefore, the pressure in the rod-side pipeline 10 becomes lower than the pressure in the hydraulic oil tank 22, and as illustrated in FIG. 3, the rod-side check valve 40 is opened, and the rod-side pipeline 10 is replenished with hydraulic oil from the hydraulic oil tank 22 via the rod-side replenishment pipeline 38. Accordingly, cavitation is prevented.

### 2. Rod Retraction When External Force Acts in Rod Retracting Direction

In the state illustrated in FIG. 2, the pressure in the cap-side pipeline 12 increases as described above, so that the pressure detected by the cap-side pressure sensor 16 becomes equal to or higher than the predetermined value. Therefore, when the rod retraction signal for the boom cylinder 8 is output from the operating device 18, the controller 20 allows the motor generator 4 to be driven by the pump motor 6.

Also, the controller 20 opens the drift reduction valve 46 to allow flow of the hydraulic oil from the cap-side port 8d to the second port 6b of the pump motor 6. As a result, as illustrated in FIG. 4, high-pressure hydraulic oil flows from the cap-side pipeline 12 into the second port 6b, the pump motor 6 rotates in reverse, and low-pressure hydraulic oil is discharged from the first port 6a. That is, hydraulic oil flows from the cap-side pipeline 12 to the rod-side pipeline 10 via the pump motor 6. At this time, the pump motor 6 acts as a hydraulic motor to drive the motor generator 4. Further, the motor generator 4 functions as a generator to generate power.

Then, hydraulic oil flows out from the cap-side port 8d of the boom cylinder 8 into the cap-side pipeline 12, and hydraulic oil flows into the rod-side port 8c from the rod-side pipeline 10. Accordingly, the piston rod 8b is retracted into the cylinder tube 8a, and the boom 58 swings (lowers) in the direction indicated by the dotted arrow B in FIG. 2.

In a case where the piston rod 8b is retracted into the cylinder tube 8a, the amount of outflow from the cap-side port 8d is greater than the amount of inflow to the rod-side port 8c by the volume of the piston rod 8b. Therefore, in a case where the rod retraction signal for the boom cylinder 8 is output from the operating device 18, as illustrated in FIG. 4, the controller 20 opens the electromagnetic proportional on-off valve 26 to discharge surplus hydraulic oil from the rod-side return pipeline 24 to the hydraulic oil tank 22.

It is desirable that the controller 20 adjusts the opening degree of the electromagnetic proportional on-off valve 26 according to the signal output from the operating device 18, and controls the amount of surplus hydraulic oil discharged from the rod-side return pipeline 24 to the hydraulic oil tank 22. Thereby, the pressure in the rod-side pipeline 10 is adjusted, and the retraction speed of the piston rod 8b can be appropriately controlled according to the signal from the operating device 18.

### Machine Lift

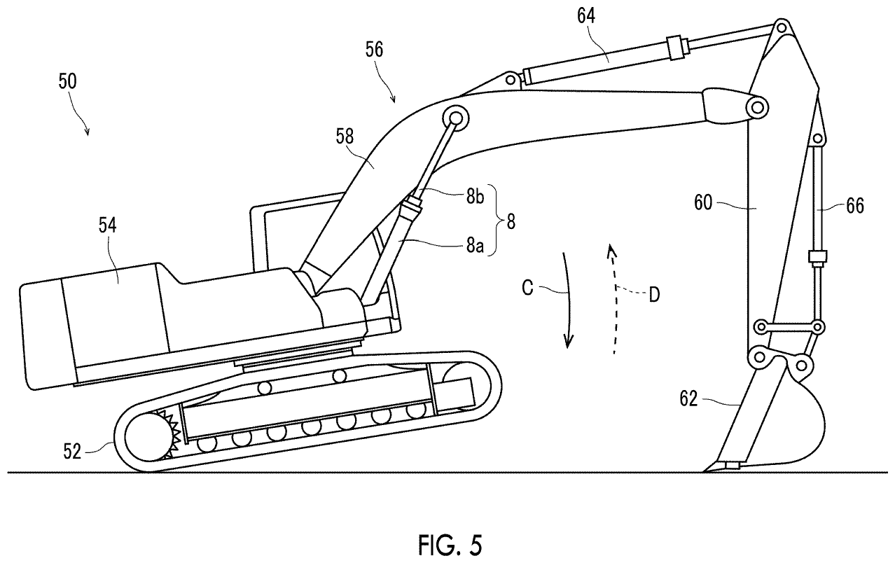

In the hydraulic excavator 50, as illustrated in FIG. 5, there is a case where the bucket 62 is pushed against the ground to tilt the machine body (the lower traveling body 52 and the upper swiveling body 54) (sometimes called a machine lift). In such a case, an external force acts on the boom cylinder 8 in the rod push-out direction, and the pressure in the rod-side pipeline 10 increases.

### 3. Rod Push-Out When External Force Acts in Rod Push-Out Direction

In the state illustrated in FIG. 5, the pressure in the rod-side pipeline 10 increases, so that the pressure detected by the rod-side pressure sensor 14 becomes equal to or higher than a predetermined value. The predetermined value of the pressure detected by the rod-side pressure sensor 14 at this time does not need to be the same as the predetermined value of the pressure detected by the cap-side pressure sensor 16 (a predetermined value for allowing the motor generator 4 to be driven by the pump motor 6 in a case where the rod retraction signal is output).

Then, in the state illustrated in FIG. 5, when a rod push-out signal for the boom cylinder 8 is output from the operating device 18, the controller 20 supplies electric power from the battery to the motor generator 4 to rotate the motor generator 4 forward. As a result, the pump motor 6 rotates forward, and hydraulic oil flows into the first port 6a of the pump motor 6, and hydraulic oil flows out from the second port 6b. In other words, hydraulic oil flows from the rod-side pipeline 10 to the cap-side pipeline 12 via the pump motor 6.

Further, since hydraulic oil flows out from the rod-side port 8c of the boom cylinder 8 into the rod-side pipeline 10 and hydraulic oil flows into the cap-side port 8d from the cap-side pipeline 12, the piston rod 8b is pushed out from the cylinder tube 8a. Accordingly, the machine body (the lower traveling body 52 and the upper swiveling body 54) swings in the direction indicated by a solid arrow C in FIG. 5.

As described above, in the state illustrated in FIG. 5, the pressure in the rod-side pipeline 10 is increased, so that the hydraulic oil flowing into the first port 6a is at high pressure. Accordingly, when the pump motor 6 rotates forward and a flow is generated from the rod-side pipeline 10 to the cap-side pipeline 12, the controller 20 may stop the electric power supply from the battery to the motor generator 4, may cause the pump motor 6 to rotate forward by the high-pressure hydraulic oil flowing into the first port 6a, and may rotate the motor generator 4 forward by the rotation of the pump motor 6.

That is, in a case where an external force acts in the rod push-out direction (in a case where the pressure detected by the rod-side pressure sensor 14 is equal to or higher than a predetermined value), when the rod push-out signal is output, the controller 20 first causes the motor generator 4 to drive the pump motor 6 as a hydraulic pump, and after a predetermined period of time has elapsed since the pump motor 6 started to be driven, the controller 20 may switch the pump motor 6 to a hydraulic motor and cause the motor generator 4 to generate power.

As described above, in a case where the piston rod 8b is pushed out from the cylinder tube 8a, the amount of outflow from the rod-side port 8c is smaller than the amount of inflow into the cap-side port 8d by the volume of the piston rod 8b, but when an external force acts in the rod push-out direction, the pressure in the rod-side pipeline 10 becomes higher than the pressure in the hydraulic oil tank 22. Therefore, the rod-side check valve 40 does not open.

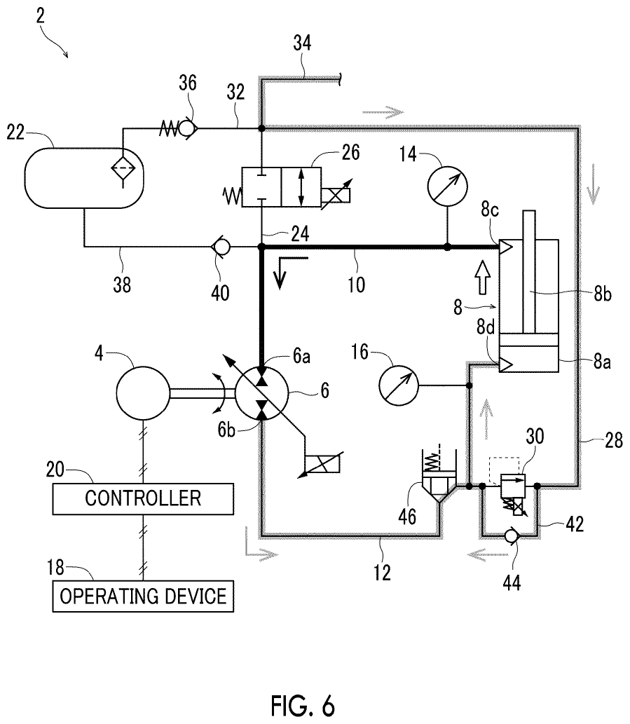

However, in the illustrated embodiment, since the back pressure check valve 36 is provided in the confluence return pipeline 32 connected to the cap-side return pipeline 28, the pressure in the cap-side pipeline 12 becomes lower than the pressure in the cap-side return pipeline 28, the cap-side check valve 44 is opened as illustrated in FIG. 6, and the cap-side pipeline 12 is replenished with hydraulic oil from the cap-side replenishment pipeline 42. Accordingly, cavitation is prevented.

### 4. Rod Retraction When External Force Acts in Rod Push-Out Direction

In the state illustrated in FIG. 5, there is no pressure in the cap-side pipeline 12, and the pressure detected by the cap-side pressure sensor 16 becomes less than the predetermined value. Therefore, when a rod retraction signal for the boom cylinder 8 is output from the operating device 18, the controller 20 supplies electric power from the battery to the motor generator 4 to rotate the motor generator 4 in reverse. This causes the pump motor 6 to rotate in reverse. In this way, the motor generator 4 functions as an electric motor and the pump motor 6 acts as a hydraulic pump.

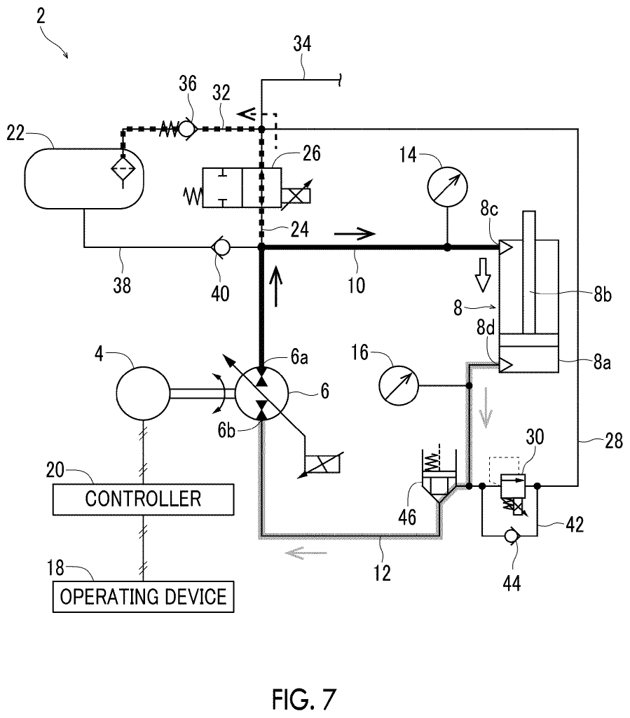

Also, the controller 20 opens the drift reduction valve 46 to allow flow of the hydraulic oil from the cap-side port 8d to the second port 6b of the pump motor 6. As a result, as illustrated in FIG. 7, low-pressure hydraulic oil in the cap-side pipeline 12 is sucked into the second port 6b, and high-pressure hydraulic oil is discharged from the first port 6a to the rod-side pipeline 10. That is, hydraulic oil flows from the cap-side pipeline 12 to the rod-side pipeline 10 via the pump motor 6.

As a result, hydraulic oil flows out from the cap-side port 8d of the boom cylinder 8 into the cap-side pipeline 12, and hydraulic oil flows into the rod-side port 8c from the rod-side pipeline 10. Accordingly, the piston rod 8b is retracted into the cylinder tube 8a, and the machine body (the lower traveling body 52 and the upper swiveling body 54) swings in the direction indicated by a dotted arrow D in FIG. 5.

Also, in a case where a rod retraction signal for the boom cylinder 8 is output from the operating device 18, the controller 20 opens the electromagnetic proportional on-off valve 26 in the same manner as when an external force acts on the boom cylinder 8 in the rod retracting direction. Thereby, surplus hydraulic oil is discharged from the rod-side return pipeline 24 to the hydraulic oil tank 22.

Also in this case, it is desirable that the controller 20 adjusts the opening degree of the electromagnetic proportional on-off valve 26 according to the signal output from the operating device 18, and controls the amount of surplus hydraulic oil discharged from the rod-side return pipeline 24 to the hydraulic oil tank 22. Thereby, the pressure of the hydraulic oil flowing into the rod-side port 8c is adjusted, and the retraction speed of the piston rod 8b can be appropriately controlled according to the signal from the operating device 18.

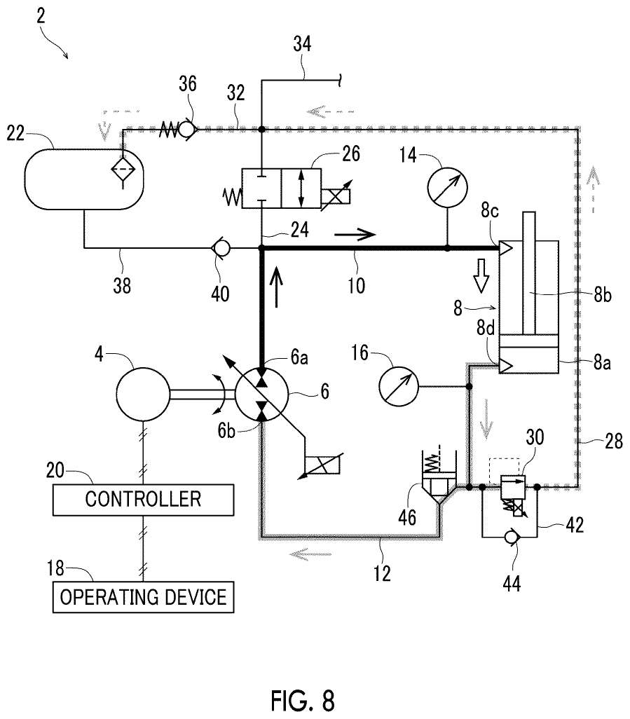

Alternatively, in a case where an external force acts on the boom cylinder 8 in the rod push-out direction and a rod retraction signal for the boom cylinder 8 is output from the operating device 18, the controller 20 may reduce the relief pressure of the electromagnetic proportional relief valve 30 to discharge surplus hydraulic oil from the cap-side return pipeline 28 to the hydraulic oil tank 22, as illustrated in FIG. 8. Thereby, the amount of inflow from the cap-side pipeline 12 to the pump motor 6 can be reduced, and power loss can be suppressed. At this time, the electromagnetic proportional on-off valve 26 may be opened or closed.

In addition, the controller 20 adjusts the rotation speed of the motor generator 4 and the displacement of the pump motor 6 according to the signal output from the operating device 18 regardless of whether the rod push-out signal or the rod retraction signal is output. Thus, the push out speed or retracting speed of the piston rod 8b of the boom cylinder 8 can be controlled appropriately.

As described above, in the hydraulic circuit 2, in a case where a rod push-out signal for the boom cylinder 8 is output from the operating device 18, hydraulic oil flows from the rod-side pipeline 10 to the cap-side pipeline 12 via the pump motor 6, and in a case where a rod retraction signal for the boom cylinder 8 is output from the operating device 18, hydraulic oil flows from the cap-side pipeline 12 to the rod-side pipeline 10 via the pump motor 6. Therefore, a directional switching valve for switching the operating direction of the boom cylinder 8 is not required. Accordingly, no pressure loss occurs in the directional switching valve, and good energy efficiency is achieved.

1. A hydraulic circuit for a construction machine with a boom, the hydraulic circuit comprising:
a motor generator;
a variable displacement bidirectional pump motor connected to the motor generator;
a boom cylinder for operating the boom;
a rod-side pipeline that connects the pump motor and a rod-side port of the boom cylinder;
a cap-side pipeline that connects the pump motor and a cap-side port of the boom cylinder;
an operating device that outputs a signal for operating the boom cylinder; and
a controller that performs circuit control based on a signal output from the operating device, wherein
in a case where a rod push-out signal for the boom cylinder is output from the operating device, hydraulic oil flows from the rod-side pipeline to the cap-side pipeline via the pump motor, and
in a case where a rod retraction signal for the boom cylinder is output from the operating device, hydraulic oil flows from the cap-side pipeline to the rod-side pipeline via the pump motor.

2. The hydraulic circuit for a construction machine according to claim 1, further comprising:
a cap-side pressure sensor that detects pressure in the cap-side pipeline, wherein
in a case where the rod retraction signal for the boom cylinder is output from the operating device, the controller causes the motor generator to drive the pump motor when the pressure detected by the cap-side pressure sensor is less than a predetermined value, and allows the motor generator to be driven by the pump motor when the pressure detected by the cap-side pressure sensor is equal to or higher than the predetermined value.

3. The hydraulic circuit for a construction machine according to claim 1, further comprising:
a rod-side return pipeline that connects the rod-side pipeline and a hydraulic oil tank; and
an electromagnetic proportional on-off valve disposed in the rod-side return pipeline, wherein
when the rod retraction signal for the boom cylinder is output from the operating device, the controller opens the electromagnetic proportional on-off valve to discharge surplus hydraulic oil from the rod-side return pipeline.

4. The hydraulic circuit for a construction machine according to claim 3, wherein the controller adjusts an opening degree of the electromagnetic proportional on-off valve according to the signal output from the operating device, and controls an amount of surplus hydraulic oil discharged from the rod-side return pipeline.

5. The hydraulic circuit for a construction machine according to claim 1, further comprising:
a cap-side return pipeline that connects the cap-side pipeline and a hydraulic oil tank; and
an electromagnetic proportional relief valve disposed in the cap-side return pipeline, wherein
when the rod retraction signal for the boom cylinder is output from the operating device, the controller reduces relief pressure of the electromagnetic proportional relief valve to discharge surplus hydraulic oil from the cap-side return pipeline.

6. The hydraulic circuit for a construction machine according to claim 1, further comprising:
a rod-side replenishment pipeline connected to the rod-side pipeline;
a rod-side check valve disposed in the rod-side replenishment pipeline;
a cap-side replenishment pipeline connected to the cap-side pipeline; and
a cap-side check valve disposed in the cap-side replenishment pipeline, wherein
in a case where the rod push-out signal for the boom cylinder is output from the operating device, the rod-side check valve opens to replenish the rod-side pipeline with hydraulic oil, or the cap-side check valve opens to replenish the cap-side pipeline with hydraulic oil.

7. The hydraulic circuit for a construction machine according to claim 1, wherein
the cap-side pipeline is provided with a drift reduction valve that allows flow from the pump motor to the cap-side port and blocks flow from the cap-side port to the pump motor, and
in a case where the rod retraction signal for the boom cylinder is output from the operating device, the controller opens the drift reduction valve to allow flow from the cap-side port to the pump motor.

8. The hydraulic circuit for a construction machine according to claim 1, wherein the controller adjusts a rotation speed of the motor generator and a displacement of the pump motor according to the signal output from the operating device.
